(19) United States
(12) Patent Application Publication
(10) Pub. No.: US 2025/0202053 A1
(43) Pub. Date: Jun. 19, 2025

(54) ELASTIC SHEETS FOR ALL-SOLID-STATE RECHARGEABLE BATTERIES AND ALL-SOLID-STATE RECHARGEABLE BATTERIES

(71) Applicant: SAMSUNG SDI CO., LTD., Yongin-si (KR)

(72) Inventors: Jiwan YOU, Yongin-si (KR); Ik Hwan Cho, Yongin-si (KR); Changhee Woo, Yongin-si (KR); Young Gyoon Ryu, Yongin-si (KR)

(21) Appl. No.: 18/926,430

(22) Filed: Oct. 25, 2024

(30) Foreign Application Priority Data
Dec. 15, 2023 (KR) 10-2023-0183526

(51) Int. Cl. H01M 50/446; H01M 50/42; H01M 50/431

(52) U.S. Cl. CPC H01M 50/446; H01M 50/42; H01M 50/431

(57) ABSTRACT

An elastic sheet for an all-solid-state rechargeable battery, the elastic sheet includes a curable resin; and an insulating filler, wherein the elastic sheet has a dielectric breakdown strength of about 7 kV/mm to about 15 kV/mm, an elongation of greater than or equal to about 150%, and a tensile strength of about 3 MPa to about 6 MPa.

### CROSS-REFERENCE TO RELATED APPLICATION

This application claims priority to and the benefit of Korean Patent Application No. 10-2023-0183526 filed in the Korean Intellectual Property Office on Dec. 15, 2023, the entire contents of which are incorporated herein by reference.

### BACKGROUND

### 1. Field

Embodiments relate to elastic sheets for all-solid-state rechargeable batteries and all-solid-state rechargeable batteries.

### 2. Description of the Related Art

A portable information device such as a cell phone, a laptop, smart phone, or the like or an electric vehicle may use a rechargeable lithium battery having high energy density and easy portability as a driving power source. Recently, research has been actively conducted to use a rechargeable lithium battery with high energy density as a driving power source or power storage power source for hybrid or electric vehicles.

### SUMMARY

The embodiments may be realized by providing an elastic sheet for an all-solid-state rechargeable battery, the elastic sheet including a curable resin; and an insulating filler, wherein the elastic sheet has a dielectric breakdown strength of about 7 kV/mm to about 15 kV/mm, an elongation of greater than or equal to about 150%, and a tensile strength of about 3 MPa to about 6 MPa.

The elastic sheet may have a dielectric breakdown strength of about 7 kV/mm to about 16 kV/mm.

The elastic sheet may have an elongation of about 150% to about 200%.

The elastic sheet may have a thickness of about 100 μm to about 5 mm.

The elastic sheet may have a thickness of about 100 μm to about 800 μm.

The elastic sheet may be in a form of foam rubber, a sheet form, a foam sheet form, an injection molded product, or a foam injection molded product.

The curable resin may include a urethane resin, an acrylic resin, a silicone resin, a fluorine resin, a styrene resin, a vinyl acetate resin, a rubber resin, a copolymer thereof, or a mixture thereof.

The curable resin may include a urethane resin, and the urethane resin may be prepared from a polyol having a weight average molecular weight of greater than or equal to about 4,000 g/mol.

The urethane resin may be prepared from a polyol having a weight average molecular weight of about 5,000 g/mol to about 10,000 g/mol.

The insulating filler may include boron nitride (BN), silicon dioxide (SiO₂), alumina (AlO₃), zinc oxide (ZnO), aluminum hydroxide (Al(OH)₃), zirconia (ZrO₂), barium oxide (BaO), magnesium oxide (MgO₂), aluminum nitride (AlN), strontium oxide (SrO), or a combination thereof.

The insulating filler may be in a particle form and may have an average particle diameter (D₅₀) of about 10 nm to about 25 μm.

The insulating filler may be included in an amount of about 5 parts by weight to about 30 parts by weight, based on 100 parts by weight of the curable resin.

The elastic particles may include a polymer of alkyl acrylate, olefin, butadiene, isoprene, styrene, acrylonitrile, a copolymer thereof, or a combination thereof.

The elastic particles may have an average particle diameter (D₅₀) of about 10 nm to about 900 nm.

The elastic particles may be included in an amount of about 0.1 parts by weight to about 5 parts by weight, based on 100 parts by weight of the curable resin.

The inorganic particles may include titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or a combination thereof.

The inorganic particles may be included in an amount of about 0.001 to about 50 parts by weight, based on 100 parts by weight of the curable resin.

The elastic sheet may further include an additive, wherein the additive includes an initiator, a crosslinking agent, a coupling agent, a surfactant, or a combination thereof.

The additive may be included in an amount of about 0.001 parts by weight to about 5 parts by weight, based on 100 parts by weight of the curable resin.

The embodiments may be realized by providing an all-solid-state rechargeable battery including two or more cell structures, each cell structure including a positive electrode, a negative electrode, and a solid electrolyte layer, the solid electrolyte layer being between the positive electrode and negative electrode; and the elastic sheet according to an embodiment between the two or more cell structures or at an outermost portion of the two or more cell structures.

The all-solid-state rechargeable battery may be applied to an electric vehicle, a motorcycle, an electric bicycle, a drone, a ship, a train, or an aviation device.

### BRIEF DESCRIPTION OF THE DRAWINGS

Features will be apparent to those of skill in the art by describing in detail exemplary embodiments with reference to the attached drawings in which:

FIGS. 1 and 2 are cross-sectional views schematically showing all-solid-state rechargeable batteries according to some embodiments.

FIG. 3 is a graph showing the results of a penetration experiment for the all-solid-state rechargeable battery cell of Example 1, showing the temperature change and voltage change over time after penetration.

### DETAILED DESCRIPTION

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a suitable method, e.g., by using a particle size analyzer, or by using a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or length of the long axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### Elastic Sheet

In some embodiments, an elastic sheet for an all-solid-state rechargeable battery may include a curable resin and an insulating filler. In an implementation, the elastic sheet may have a dielectric breakdown strength of about 7 kV/mm to about 15 kV/mm, a tensile strength of about 3 MPa to about 6 MPa, and an elongation of greater than or equal to about 150%.

The elastic sheet may help ensure or provide good contact between solid components by ensuring that pressure is evenly transmitted to the cell structure (or electrode assembly), may also help relieve stress transmitted to the solid electrolyte, etc., and may help suppress cracks in the solid electrolyte due to stress accumulation as the thickness of the electrode changes during charging and discharging to play a role in buffering changes in the volume of the battery. The elastic sheet may be between the cell structures, on the outermost surface of the cell structures, or on an inner surface of the case.

An all-solid-state rechargeable battery may secure fire safety by using a solid electrolyte instead of a liquid electrolyte. If the solid electrolyte were to be destroyed due to, e.g., penetration or collision, positive and negative electrodes could contact each other to cause a short circuit and increase a temperature inside the battery, leading to a fire. Accordingly, some embodiments may include applying an insulating filler to an elastic sheet to help improve dielectric breakdown strength and elongation and secure appropriate tensile strength and thereby, preventing the short circuit, even if the solid electrolyte were to be destroyed due to the penetration or the like and thus effectively preventing the fire or explosion. The elastic sheet according to some embodiments may have excellent mechanical properties such as voltage resistance, chemical resistance, dimensional stability, elongation, or the like, as well as high thermal and electrical safety and in addition, may have advantages of being economical due to a low cost and being free to control a thickness due to containing no graphite compound. An all-solid-state rechargeable battery using such an elastic sheet may help ensure thermal, electrical, and physical safety, may have improved reliability, and may be used in various fields such as an electric vehicle, a motorcycle, an electric bicycle, a drone, a ship, a train, or an aviation device.

The dielectric breakdown strength of the elastic sheet according to some embodiments may be greater than or equal to about 7 kV/mm. The dielectric breakdown strength refers to a value obtained by dividing a minimum voltage required to cause dielectric breakdown by a thickness of a specimen. If the battery were to be in a situation such as penetration and the like, as the elastic sheet is stretched, the stretched portion may become thinner. In an implementation, the elastic sheet may have dielectric breakdown strength of about 7 kV/mm or more, and even if a stretched portion were to become thinner, and the elastic sheet may maintain insulating properties, preventing the short circuit of the battery and suppressing ignition.

The dielectric breakdown strength may be measured according to ASTM D149, e.g., as described in Evaluation Example 1, below. The dielectric breakdown strength of the elastic sheet may be, e.g., about 7 kV/mm to about 20 kV/mm, about 7 kV/mm to about 18 kV/mm, about 7 kV/mm to about 16 kV/mm, or about 7 kV/mm to about 15 kV/mm. Within these ranges, the elastic sheet may maintain insulating properties even in the situation such as penetration and the like and thus may help improve fire safety of the battery.

The elastic sheet may have an elongation of greater than or equal to about 150%. The elongation refers to a rate that a material is stretched in a tensile test and may be measured, e.g., at about 500 mm/min according to ASTM D3574, as described below in Evaluation Example 2. In an implementation, the elongation may be about 150% or more, the elastic sheet may be neither easily torn nor broken in the situations such as penetration and the like, and may be appropriately stretched and thus function as an insulating layer, resultantly improving fire safety of the batteries. The elastic sheet may have elongation of, e.g., about 150% to about 250% or about 150% to about 200%.

The elastic sheet may have tensile strength of about 3 MPa to about 6 MPa. The tensile strength refers to maximum stress capable of withstanding a pulling force and may be measured, e.g., at about 500 mm/min according to ASTM D3574, as described below in Evaluation Example 3. Maintaining the tensile strength at about 3 MPa or greater may help ensure that the elastic sheet may not be torn apart in the situations such as penetration and the like and thus failing in acting as an insulating layer. Maintaining the tensile strength at about 6 MPa or less may help ensure that the elastic sheet is not broken in the situation such as penetration and the like and thus may still act as an insulating layer. The elastic sheet according to some embodiments may have, e.g., a tensile strength of about 3.2 MPa to about 5.8 MPa.

The elastic sheet according to some embodiments may have elongation of about 150% or more and simultaneously, tensile strength of about 3 MPa to about 6 MPa and in addition, dielectric breakdown strength of about 7 kV/mm or more and thus may be neither torn apart nor broken but appropriately stretched to withstand a pressure, preventing the short circuit of the battery and thus effectively preventing ignition or explosion of the battery.

The elastic sheet may have a thickness of about 100 μm to about 5 mm, e.g., about 100 μm to about 4,000 μm, about 100 μm to about 3,000 μm, about 100 μm to about 2,000 μm, about 100 μm to about 1,500 μm, about 100 μm to about 1,000 μm, or about 100 μm to about 800 μm. The elastic sheet according to some embodiments may have a thin thickness to realize thin batteries or maximize capacity of the batteries but still realize sufficient recovery, e.g., about 100 μm to about 800 μm, about 200 μm to about 800 μm, about 300 μm to about 800 μm, or about 300 μm to about 600 μm.

The elastic sheet may be a relatively soft pad with a low modulus or a relatively hard foam (foam rubber) and in the form of various injection molded products.

The elastic sheet may include a curable resin and an insulating filler.

### Curable Resin

The curable resin refers to a polymer that has the property of being cured with energy such as heat or ultraviolet rays. In an implementation, the curable resin may include a urethane resin, an acrylic resin, a silicone resin, a fluorine resin, a styrene resin, a vinyl acetate resin, a rubber resin, a copolymer thereof, or a mixture thereof.

The urethane resin may be referred to as polyurethane and refers to a homopolymer or copolymer having a urethane group. The acrylic resin may be, e.g., polyacrylate, and refers to a homopolymer or copolymer having an acrylic group. The silicone resin refers to a homopolymer or copolymer containing silicon, and the fluorine resin refers to a homopolymer or copolymer containing fluorine. These polymers may exhibit appropriate elasticity, strength, and elongation, making them suitable for use as elastic sheets.

The urethane resin may be derived or prepared from polyether polyol. In addition to polyether polyol, polyester polyol may be used for a urethane resin. In an implementation, the polyester polyol may be obtained by condensation of low molecular weight polyols such as ethylene glycol, diethylene glycol, propylene glycol, butanediol, hexanediol, glycerin, trimethylolpropane, trimethylolethane, pentaerythritol, diglycerin, sorbitol, sucrose, or the like with succinic acid, sebacic acid, maleic acid, fumaric acid, phthalic acid, isophthalic acid, succinic anhydride, maleic anhydride, phthalic anhydride, or the like. In an implementation, the polyester polyol may include polyols that are ring-opening condensates of caprolactone and methylvalerolactone, which are classified as lactone esters. A polycarbonate polyol may be obtained by a dealcoholization reaction of polyhydric alcohols such as ethylene glycol, diethylene glycol, propylene glycol, butanediol, pentanediol, or hexanediol with dialkyl carbonate, dialkylene carbonate, or diphenyl carbonate.

The urethane resin according to some embodiments may be derived from or prepared using a polyol having a weight average molecular weight of greater than or equal to about 4,000 g/mol. In an implementation, the polyol may have a molecular weight of greater than or equal to about 4,000 g/mol, and the elastic sheet may have an elongation of an elongation of greater than or equal to about 150% and a tensile strength of about 3 MPa to about 6 MPa, thereby improving the fire safety of the elastic sheet. The weight average molecular weight of the polyol may be, e.g., about 4,000 g/mol to about 10,000 g/mol, about 5,000 g/mol to about 10,000 g/mol, about 5,500 g/mol to about 8,000 g/mol, or about 6,000 g/mol to about 7,500 g/mol.

Examples of the acrylic resin may be derived from (e.g., polymers of) C1 to C20 alkyl acrylate, hydroxy C1 to C20 alkyl acrylate, or a combination thereof. Herein, C1 to C20 refers to the number of carbons of the alkyl group, and may be, e.g., C1 to C18, C1 to C15, C1 to C12, C1 to C10, C1 to C8, or C1 to C5. Herein, the acrylate may have a concept including acrylate and methacrylate.

The C1 to C20 alkyl acrylate may include, e.g., methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, 2-propyloctyl (meth)acrylate, or a combination thereof.

The hydroxy C1 to C20 alkyl acrylate may include, e.g., 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

In an implementation, the acrylic resin may be derived from (e.g., may be a polymer including repeating units of) C1 to C20 alkyl acrylate and hydroxy C1 to C20 alkyl acrylate, in which a mixing ratio of the C1 to C20 alkyl acrylate and hydroxy C1 to C20 alkyl acrylate may be a weight ratio of about 20:80 to about 90:10, e.g., about 30:70 to about 90:10, about 40:60 to about 90:10, about 50:50 to about 90:10, or about 60:40 to about 80:20. In this case, the acrylic resin can exhibit appropriate adhesion and is advantageous for realizing excellent compressive strength, stress relaxation rate, and recovery rate.

In an implementation, the acrylic resin may further include other repeating units of or derived from acrylic acid, acrylate including an alkoxy group, or the like. In an implementation, a weight average molecular weight of the acrylic resin may be about 400,000 to about 2,000,000.

### Insulating Filler

The elastic sheet according to some embodiments may include an insulating filler. The insulating filler may have insulating properties itself and may be an inorganic insulating filler or an organic insulating filler. In an implementation, the insulating filler may be an inorganic insulating filler. By adding an insulating filler to the elastic sheet, the elastic sheet may have insulating properties and the dielectric breakdown strength and elongation of the elastic sheet may be improved, thereby effectively preventing the battery from being short-circuited by physical force.

The insulating filler may include, e.g., boron nitride (BN), silicon dioxide (SiO₂), alumina (Al₂O₃), zinc oxide (ZnO), aluminum hydroxide (Al(OH)₃), zirconia (ZrO₂), barium oxide (BaO), magnesium oxide (MgO₂), aluminum nitride (AlN), strontium oxide (SrO), or a combination thereof.

The insulating filler may be in a particle or fibrous form. In an implementation, the insulating filler may be in the form of particles, and its average particle diameter (D₅₀) may be about 10 nm to about 25 μm, e.g., about 20 nm to about 20 μm, about 50 nm to about 10 μm, or about 100 nm to about 5 μm. Within these ranges, the insulating filler may be evenly distributed within the elastic sheet and may help improve the elongation and dielectric breakdown strength of the elastic sheet. Herein, the particle diameter of the insulating filler may be measured using a particle size analyzer, and may mean a diameter (D₅₀) of a particle with a cumulative volume of 50% by volume in a particle size distribution.

The insulating filler may be included in an amount of about 5 parts by weight to about 30 parts by weight, e.g., about 5 parts by weight to about 25 parts by weight, or about 6 parts by weight to about 20 parts by weight, based on 100 parts by weight of the curable resin. In an implementation, the insulating filler may be included at about 5 wt % to about 30 wt %, e.g. about 5 wt % to about 20 wt %, about 6 wt % to about 18 wt %, or about 6 wt % to about 15 wt %, based on a total weight of the elastic sheet. Within the above content ranges, the elastic sheet may exhibit excellent elongation, tensile strength, and dielectric breakdown strength.

### Elastic Particles

In an implementation, the elastic sheet may further include elastic particles in addition to the curable resin and insulating particles. The elastic particles may be particles made of an elastic polymer such as rubber. The elastic particles may help increase a restoring force while maintaining the stress relaxation force of the polymer resin.

The elastic particles may be included in an amount of about 0.1 to about 5 parts by weight, e.g., about 0.5 to about 4 parts by weight, or about 1 to about 3 parts by weight, based on 100 parts by weight of the polymer resin. Within these content ranges, compressive strength, stress relaxation force, and restoring force may be maximized without reducing the density and adhesion of the polymer resin.

The elastic particles may include, e.g., polymers of or derived from a natural rubber, alkyl acrylate, olefin, butadiene, isoprene, styrene, acrylonitrile, a copolymer thereof, or a combination thereof. The elastic particles may have a glass transition temperature of, e.g., about −70° C. to about 0° C.

The alkyl acrylate may be C1 to C20 alkyl acrylate, e.g., methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, 2-propyloctyl (meth)acrylate, or a combination thereof.

The elastic particles may include, e.g., an ethylene-propylene-diene rubber, a butadiene rubber, an isoprene rubber, a styrene-butadiene rubber, a styrene-isoprene rubber, an acrylonitrile-butadiene rubber, or a combination thereof.

In an implementation, the elastic particles may have a core-shell structure, in which case it may be advantageous to exhibit appropriate size and elasticity. The core and shell may each include polyalkyl acrylate, e.g., the core may include polybutyl (meth)acrylate, and the shell may include polymethyl (meth)acrylate. In this case, dispersibility may be excellent and the compressive strength, stress relaxation force, and restoring force of the elastic sheet may be improved.

In an implementation, the elastic particles may be nano-sized. In an implementation, the size (D₅₀) of the elastic particles may be about 10 nm to about 900 nm, e.g., about 10 nm to about 700 nm, about 50 nm to about 500 nm, or about 100 nm to about 400 nm. Elastic particles satisfying this size may have excellent dispersibility within the elastic sheet and may help increase the restoring force while maintaining the stress relaxation force of the elastic sheet. Herein, the size of the elastic particle may be expressed as an average particle diameter or median particle diameter, which is measured by a particle size analyzer, and can mean the diameter (D₅₀) of a particle with a cumulative volume of 50 volume % in the particle size distribution.

### Inorganic Particles

In an implementation, the elastic sheet may further include inorganic particles. In an implementation, the modulus and compressive strength of the elastic sheet may be improved while the recovery rate may be improved at the same time.

The inorganic particles may include, e.g., alumina, titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or a combination thereof.

In an implementation, the inorganic particles may be included in an amount of about 0.001 to about 50 parts by weight, e.g., about 0.01 to about 45 parts by weight, or about 0.1 to about 40 parts by weight, based on 100 parts by weight of the polymer resin. Within these ranges, the compressive strength, stress relaxation rate, and recovery rate of the elastic sheet may be improved without deteriorating the properties of the polymer resin.

An average particle diameter of the inorganic particles may be about 0.1 μm to about 5 μm, e.g., about 0.1 μm to about 2.5 μm, or about 0.2 μm to about 2 μm. The average particle size is measured using a laser scattering particle size distribution meter, and may mean the median particle size (D₅₀) when 50% of the particles are accumulated from the small particle side in volume conversion.

### Hollow Particles

In an implementation, the elastic sheet may further include hollow particles. The hollow particles may be particles with an empty interior and may be expressed as hollow spheres or hollow beads, and may be hollow nano-particles or hollow micro-particles. In an implementation, the elastic sheet may include the hollow particles, compressive strength may be increased while maintaining an appropriate density, and a foam shape may be exhibited.

The hollow particles may be included in an amount of about 1 to about 8 parts by weight, e.g., about 1 to about 7 parts by weight, or about 2 to about 6 parts by weight, based on 100 parts by weight of the polymer resin. Within these content ranges, it may be advantageous to make a foam-type elastic sheet, and the compressive strength, stress relaxation force, and restoring force of the elastic sheet may be improved.

The hollow particles may be inorganic hollow particles, organic hollow particles, or a combination thereof. In an implementation, the hollow particles may be made of inorganic materials or may be composed of organic materials such as polymers.

The inorganic hollow particles may include, e.g., glass, metal oxide, metal carbide, metal fluoride, or a combination thereof. In an implementation, the inorganic hollow particles may be made of glass, silicon oxide, nickel oxide, barium oxide, platinum oxide, zinc oxide, aluminum oxide, zirconium oxide, iron oxide, titanium oxide, calcium carbonate, magnesium fluoride, or a combination thereof. In an implementation, the inorganic hollow particle may be a glass bubble.

The organic hollow particles may include, e.g., an acrylic resin, a vinyl chloride resin, a urea resin, a phenolic resin, a rubber, or a combination thereof. In an implementation, the organic hollow particles may be expanded or non-expanded, and the expanded organic hollow particles may be expanded at, e.g., about 120° C. to about 150° C.

In an implementation, the size (D₅₀) of the hollow particle may be micro size, and may be about 1 μm to about 100 μm, about 5 μm to about 80 μm, about 10 μm to about 60 μm, or about 20 μm to about 50 μm. The hollow particles having such a size may be advantageous for making foam-shaped elastic sheets, and may help improve the compressive strength of the elastic sheet while lowering the density and improving stress relaxation force and restoring force. Herein, the size of the hollow particle can be expressed as an average particle diameter or median particle diameter, which is measured by a particle size analyzer, and can mean the diameter (D₅₀) of a particle with a cumulative volume of 50 volume % in the particle size distribution.

### Other Additives

In an implementation, the elastic sheet may further include appropriate additives in addition to the aforementioned components, e.g., an initiator, a crosslinking agent, a coupling agent, a foam stabilizer, or a combination thereof. Each additive may be included in an appropriate amount according to the purpose, e.g., about 0.001 to about 5 part by weight, for example, about 0.01 to about 0.8 parts by weight, based on 100 parts by weight of the polymer resin.

In an implementation, the elastic sheet may further include about 0.1 to about 10 parts by weight of a pigment, about 0.1 to about 10 parts by weight of an antioxidant, about 0.1 to about 10 parts by weight of a lubricant, about 0.1 to about 10 parts by weight of an antistatic agent, or a combination thereof, based on 100 parts by weight of the polymer resin.

### All-Solid-State Rechargeable Battery

In some embodiments, an all-solid-state rechargeable battery may include two or more cell structures (each including a positive electrode, a negative electrode, and a solid electrolyte layer between the positive electrode and negative electrode), and the elastic sheet located between the cell structures or at the outermost portion of the cell structures. At least one of the elastic sheets in the battery may be the aforementioned elastic sheet according to an embodiment.

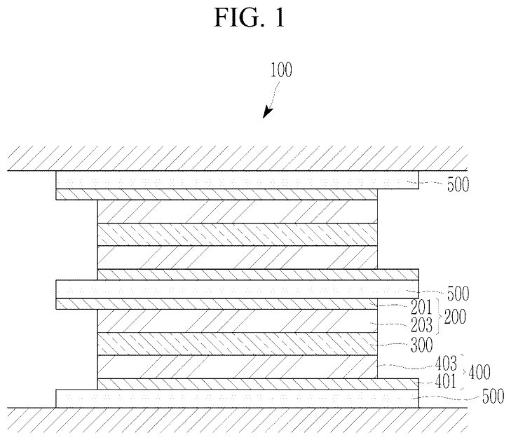

FIG. 1 is a cross-sectional view of an all-solid-state rechargeable battery according to some embodiments. Referring to FIG. 1, the all-solid-state rechargeable battery 100 may include a cell structure in which a negative electrode 400 including a negative electrode current collector 401 and a negative electrode active material layer 403, a solid electrolyte layer 300, and a positive electrode 200 including a positive electrode current collector 201 and a positive electrode active material layer 203 are stacked is housed in a battery case. In an implementation, referring to FIG. 1, an assembly may have a structure in which two cell structures including the negative electrode 400, the solid electrolyte layer 300, and the positive electrode 200 are stacked, or three or more, e.g., 2 to 200, 3 to 100, 4 to 50, etc. may be stacked.

The all-solid-state rechargeable battery 100 may include an elastic sheet 500 outside at least one of the positive electrode 200 and the negative electrode 400. In an implementation, the elastic sheet 500 may be between the cell structures or may be on the outermost portion or outer side of the cell structures. At least one of the elastic sheets 500 in the battery according to some embodiments may be the aforementioned elastic sheet. In an implementation, the all-solid-state rechargeable battery may not only address the issue of stress concentration due to volume change due to the elastic sheet, but may also effectively suppress short circuits if a penetration were to occur, thereby improving thermal and electrical safety.

### Positive Electrode

In an implementation, the positive electrode may include a current collector and a positive electrode active material layer on the current collector, and the positive electrode active material layer may include a positive electrode active material and may optionally include a solid electrolyte, a binder, or a conductive material.

### Positive Electrode Active Material

The positive electrode active material may include a compound (lithiated intercalation compound) being capable of intercalating and deintercalating lithium. In an implementation, at least one of a composite oxide of lithium and a metal selected from cobalt, manganese, nickel, and combinations thereof may be used.

The composite oxide may be a lithium transition metal composite oxide, and examples thereof may include lithium nickel oxide, lithium cobalt oxide, lithium manganese oxide, lithium iron phosphate compound, cobalt-free lithium nickel-manganese oxide, overlithiated layered oxide, or a combination thereof.

In an implementation, the positive electrode active material may be a high nickel positive electrode active material having a nickel content of greater than or equal to about 80 mol % based on 100 mol % of metals excluding lithium in the lithium transition metal composite oxide. The nickel content in the high nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of metals excluding lithium. The high-nickel positive electrode active materials can achieve high capacity and can be applied to high-capacity, high-density rechargeable lithium batteries.

In an implementation, a compound represented by any of the following chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}CO_{b}X_{c}O_{2-α}D′_{α} (0.90≤a≤1.8, 0≤b≤0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8)

In the above chemical formulas, A may be Ni, Co, Mn, or a combination thereof; X may be Al, Ni, Co, Mn, Cr, Fe, Mg, Sr, V, a rare earth element, or a combination thereof; D′ may be O, F, S, P, or a combination thereof; G may be Al, Cr, Mn, Fe, Mg, La, Ce, Sr, V, or a combination thereof; and L¹ may be Mn, Al, or a combination thereof.

The positive electrode active material may include, e.g., lithium nickel oxide represented by Chemical Formula 11, lithium cobalt oxide represented by Chemical Formula 12, a lithium iron phosphate compound represented by Chemical Formula 13, and cobalt-free lithium nickel manganese oxide represented by Chemical Formula 14, or a combination thereof.

Liₐ₁Niₓ₁M¹_{y1}M²_{z1}O_{2-b1}X_{b1} [Chemical Formula 11]

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may be each independently Al, B, Ba, Ca, Ce, Co, Cr, Cu, Fe, Mg, Mn, Mo, Nb, Si, Sn, Sr, Ti, V, W, or Zr, and X may be F, P, or S.

In Chemical Formula 1, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2} [Chemical Formula 12]

In Chemical Formula 12, 0.9≤a2≤1.8, 0.7≤x2≤1, 0≤y2≤0.3, 0.9≤x2+y2≤1.1, and 0≤b2≤0.1, M³ may be Al, B, Ba, Ca, Ce, Cr, Cu, Fe, Mg, Mn, Mo, Ni, Se, Si, Sn, Sr, Ti, V, W, Y, Zn, or Zr, and X may be F, P, or S.

Liₐ₃Feₓ₃M⁴_{y3}PO_{4-b3}X_{b3} [Chemical Formula 13]

In Chemical Formula 13, 0.9≤a3≤1.8, 0.6≤x3≤1, 0≤y3≤0.4, and 0≤b3≤0.1, M⁴ may be Al, B, Ba, Ca, Ce, Co, Cr, Cu, Mg, Mn, Mo, Ni, Se, Si, Sn, Sr, Ti, V, W, Y, Zn, or Zr, and X may be F, P, or S.

Liₐ₄Niₓ₄Mn_{y4}M⁵_{z4}O_{2-b4}X_{b4} [Chemical Formula 14]

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ may be Al, B, Ba, Ca, Ce, Cr, Fe, Mg, Mo, Nb, Si, Sn, Sr, Ti, V, W, or Zr, and X may be F, P, or S.

The average particle diameter (D₅₀) of the positive electrode active material may be about 1 μm to about 25 μm, e.g., about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D₅₀) of about 1 μm to about 9 μm and large particles having an average particle diameter (D₅₀) of about 10 μm to about 25 μm. The positive electrode active material within these particle size ranges may be harmoniously mixed with other components within the positive electrode active material layer and can achieve high capacity and high energy density. Herein, the average particle diameter may be obtained by selecting about 20 particles at random in the scanning electron microscope image of the positive electrode active material, measuring the particle diameter (e.g., diameter, long axis, or length of the long axis) to obtain the particle size distribution, and taking the diameter (D₅₀) of particles with a cumulative volume of 50 volume % as the average particle diameter in the particle size distribution.

The positive electrode active material may be in the form of secondary particles made by agglomerating a plurality of primary particles, or may be in the form of single particles. In an implementation, the positive electrode active material may have a spherical or close to spherical shape, or may have a polyhedral or irregular shape.

In an implementation, the positive electrode active material may include a buffer layer on the particle surface. The buffer layer may be expressed as a coating layer, a protective layer, etc., and may play a role in lowering the interfacial resistance between the positive electrode active material and the sulfide-based solid electrolyte particles. In an implementation, the buffer layer may include lithium-metal-oxide, and the metal may be, e.g., Al, B, Ca, Ce, Cr, Fe, Mg, Mo, Nb, Si, Sn, Sr, Ta, V, W, or Zr. The lithium-metal-oxide may be excellent for improving the performance of the positive electrode active material by facilitating the movement of lithium ions and electronic conduction, while lowering the interfacial resistance between the positive electrode active material and solid electrolyte particles.

The positive electrode active material may be included in an amount of about 55 wt % to about 99.5 wt %, e.g., about 65 wt % to about 95 wt %, or about 75 wt % to about 91 wt %, based on 100 wt % of the positive electrode active material layer.

### Binder

The binder may help improve binding properties of positive electrode active material particles with one another and with a current collector. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon.

### Conductive Material

The conductive material may provide electrode conductivity and a suitable electrically conductive material may be used as a conductive material unless it causes a chemical change. Examples of the conductive material may include a carbon material such as natural graphite, artificial graphite, carbon black, acetylene black, ketjen black, a carbon fiber, a carbon nanofiber, a carbon nanotube, or the like; a metal material of a metal powder or a metal fiber including copper, nickel, aluminum, silver, or the like; a conductive polymer such as a polyphenylene derivative; or a mixture thereof.

The contents of the binder and the conductive material may be about 0.5 wt % to about 5 wt %, respectively, based on 100 wt % of the positive electrode active material layer.

The positive electrode active material layer may optionally further include a solid electrolyte. The solid electrolyte may include, e.g., a sulfide solid electrolyte, an oxide solid electrolyte, a halide solid electrolyte, or a combination thereof, and detailed descriptions thereof will be provided below in the solid electrolyte layer section.

Based on 100 wt % of the positive electrode active material layer, the solid electrolyte may be included in an amount of about 0.1 wt % to about 35 wt %, e.g., about 1 wt % to about 35 wt %, about 5 wt % to about 30 wt %, about 8 wt % to about 25 wt %, or about 10 wt % to about 20 wt %.

In the positive electrode active material layer, based on a total of 100 wt % of the positive electrode active material and the solid electrolyte, about 65 wt % to about 99 wt % of the positive electrode active material and about 1 wt % to about 35 wt % of the solid electrolyte may be included, e.g., about 80 wt % to about 90 wt % of the positive electrode active material and about 10 wt % to about 20 wt % of the solid electrolyte. Within these amount ranges, the efficiency and cycle-life characteristics of the all-solid-state rechargeable battery may be improved without reducing the capacity.

The current collector may include Al.

### Negative Electrode

The negative electrode for an all-solid-state rechargeable battery may include a current collector and a negative electrode active material layer on the current collector. The negative electrode active material layer may include a negative electrode active material and may further include a binder or a conductive material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g. crystalline carbon, amorphous carbon, or a combination thereof as a carbon negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn-based negative electrode active material. The Si negative electrode active material may include silicon, a silicon-carbon composite, SiOₓ (0<x≤2), a Si-Q alloy (wherein Q is an element selected from an alkali metal, an alkaline-earth metal, a Group 13 element, a Group 14 element (excluding Si), a Group 15 element, a Group 16 element, a transition metal, a rare earth element, and a combination thereof), or a combination thereof. The Sn negative electrode active material may be Sn, SnO₂, a Sn alloy, or a combination thereof.

The silicon-carbon composite may be a composite of silicon and amorphous carbon. In an implementation, the silicon-carbon composite may be in the form of silicon particles and amorphous carbon coated on the surface of the silicon particles. In an implementation, it may include a secondary particle (core) in which silicon primary particles are assembled and an amorphous carbon coating layer (shell) on the surface of the secondary particle. The amorphous carbon may also be present between the silicon primary particles, e.g., the silicon primary particles may be coated with amorphous carbon. The secondary particles may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on the surface of the core.

The Si negative electrode active material or Sn negative electrode active material may be mixed with the carbon negative electrode active material.

In the negative electrode active material layer, the negative electrode active material may be included in an amount of about 95 wt % to about 99 wt % based on a total weight of the negative electrode active material layer. In an implementation, the negative electrode active material layer may include about 90 wt % to about 99 wt % of the negative electrode active material, about 0.5 wt % to about 5 wt % of the binder, and about 0 wt % to about 5 wt % of the conductive material.

The binder may well adhere the negative electrode active material particles to each other and also to adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

In an implementation, an aqueous binder may be used as the negative electrode binder, and a cellulose compound capable of imparting viscosity may be further included. In an implementation, the cellulose compound may include, e.g., carboxymethyl cellulose, hydroxypropylmethyl cellulose, methyl cellulose, or alkali metal salts thereof. The alkali metal may be Na, K, or Li.

The dry binder may be a polymer material capable of becoming fiber, and may be, e.g., polytetrafluoroethylene, polyvinylidene fluoride, a polyvinylidene fluoride-hexafluoropropylene copolymer, polyethylene oxide, or a combination thereof.

The conductive material may provide electrode conductivity and a suitable electrically conductive material may be used as a conductive material unless it causes a chemical change. Examples of the conductive material include a carbon material such as natural graphite, artificial graphite, carbon black, acetylene black, ketjen black, a carbon fiber, a carbon nanofiber, a carbon nanotube, and the like; a metal material of a metal powder or a metal fiber including copper, nickel, aluminum silver, and the like; a conductive polymer such as a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal, or a combination thereof.

### Precipitation-Type Negative Electrode

In an implementation, the negative electrode for an all-solid-state rechargeable battery may be a precipitation-type negative electrode. The precipitation-type negative electrode may not include a negative electrode active material during battery assembly, but refers to a negative electrode in which lithium metal, etc. is precipitated or electrodeposited during battery charging, thereby serving as a negative electrode active material.

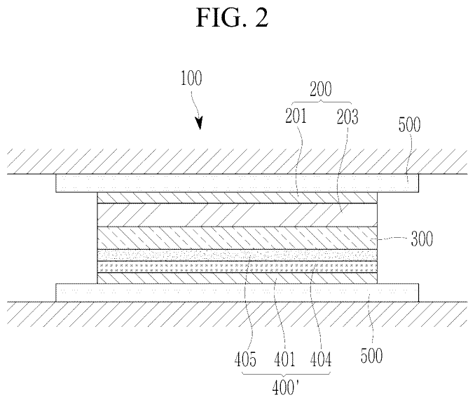

FIG. 2 is a schematic cross-sectional view of an all-solid-state rechargeable battery including a precipitation-type negative electrode. Referring to FIG. 2, the precipitation-type negative electrode 400′ may include a negative electrode current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal may be precipitated or electrodeposited between the negative electrode current collector 401 and the negative electrode coating layer 405 or on the negative electrode coating layer 405 to form a lithium metal layer 404, which may serve as a negative electrode active material. Accordingly, in an all-solid-state rechargeable battery that has been charged at least once, the precipitation-type negative electrode 400′ may include, e.g., a negative electrode current collector 401, a lithium metal layer 404 on the negative electrode current collector 401, and a negative electrode coating layer 405 on the lithium metal layer 404. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof.

The metal may be a lithiophilic metal and may include, e.g., gold, platinum, palladium, silicon, silver, aluminum, bismuth, tin, zinc, or a combination thereof, and may be composed of one of these or various types of alloys. In an implementation, the lithiophilic metal may exist in particle form, and its average particle diameter (D₅₀) may be less than or equal to about 4 μm, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

In an implementation, the negative electrode coating layer 405 may include both the metal and the carbon material, and the mixing ratio of the metal and the carbon material may be, e.g., a weight ratio of about 1:10 to about 2:1. In this case, precipitation of lithium metal may be effectively promoted and the characteristics of the all-solid-state rechargeable battery may be improved. In an implementation, the negative electrode coating layer 405 may include a carbon material on which a catalyst metal is supported, or may include a mixture of metal particles and carbon material particles.

In an implementation, the negative electrode coating layer 405 may include the lithiophilic metal and amorphous carbon, and in this case, it may help effectively promote precipitation of lithium metal. In an implementation, the negative electrode coating layer 405 may include a composite in which a lithiophilic metal is supported on amorphous carbon.

The negative electrode coating layer 405 may further include a binder, and the binder may be, e.g., a conductive binder. In an implementation, the negative electrode coating layer 405 may further include suitable additives, e.g., a filler, a dispersant, an ion conductive agent, or the like.

A thickness of the negative electrode coating layer 405 may be, e.g., about 100 nm to about 20 μm, or about 500 nm to about 10 μm, or about 1 μm to about 5 μm.

In an implementation, the precipitation-type negative electrode 400′ may further include a thin film, e.g., on the surface of the current collector or between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may further planarize a precipitation shape of the lithium metal layer 404 and much improve characteristics of the all-solid-state rechargeable battery. The thin film may be formed, e.g., in a vacuum deposition method, a sputtering method, a plating method, or the like. The thin film may have, e.g., a thickness of about 1 nm to about 500 nm.

The lithium metal layer 404 may include a lithium metal or a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be about 1 μm to about 500 μm, about 1 μm to about 200 μm, about 1 μm to about 100 μm, or about 1 μm to about 50 μm. Maintaining the thickness of the lithium metal layer 404 at about 1 μm or greater may help facilitate performing the role of a lithium storage. Maintaining the thickness of the lithium metal layer 404 at about 500 μm or less may help prevent an increase in the battery volume may increase, thereby preventing a deterioration in performance.

In an implementation, such a precipitation-type negative electrode 400′ may be applied, and the negative electrode coating layer 405 may serve to protect the lithium metal layer 404 and suppress the precipitation growth of lithium dendrite. Accordingly, short circuit and capacity degradation of the all-solid-state battery may be suppressed, and cycle-life characteristics can be improved.

### Solid Electrolyte Layer

The solid electrolyte layer may include a solid electrolyte. The solid electrolyte may be a type of inorganic solid electrolyte, and may include, e.g., a sulfide solid electrolyte, an oxide solid electrolyte, a halide solid electrolyte, or a combination thereof. The solid electrolyte layer according to some embodiments may include a sulfide solid electrolyte.

### Sulfide Solid Electrolyte

The sulfide solid electrolyte may include, e.g., Li₂S—P₂S₅, Li₂S—P₂S₅—LiX (wherein X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are an integer, respectively, and Z is Ge, Zn, or Ga), Li₂S—GeS₂, Li₂S—SiS₂—Li₃PO₄, Li₂S—SiS₂-LiₚMO_{q} (wherein p and q are integers, and M is P, Si, Ge, B, Al, Ga, or In), or a combination thereof.

Such a sulfide solid electrolyte may be obtained by, e.g., mixing Li₂S and P₂S₅ in a molar ratio of about 50:50 to about 90:10 or about 50:50 to about 80:20 and optionally performing heat-treatment. Within the above mixing ratio ranges, a sulfide solid electrolyte having excellent ionic conductivity may be prepared. In an implementation, the ionic conductivity may be further improved by adding SiS₂, GeS₂, B₂S₃, and the like as other components thereto.

Mechanical milling or a solution method may be applied as a mixing method of sulfur-containing raw materials for preparing a sulfide solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat-treatment after mixing, crystals of the solid electrolyte may be more robust and ionic conductivity may be improved. In an implementation, the sulfide solid electrolyte may be prepared by mixing sulfur-containing raw materials and performing heat treatment two or more times. In this case, a sulfide solid electrolyte having high ionic conductivity and robustness may be prepared.

The sulfide solid electrolyte particles according to some embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte can be synthesized through the second heat treatment. Through such two or more heat treatments, a sulfide solid electrolyte having high ionic conductivity and high performance can be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include an argyrodite-type sulfide solid electrolyte particle. The argyrodite-type sulfide solid electrolyte particle may have high ionic conductivity close to the range of about 10⁻⁴ to about 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

In an implementation, the argyrodite-type sulfide solid electrolyte particles may include a compound represented by Chemical Formula 21.

(LiₐM¹_{b}M²_{c})(P_{d}M³ₑ)(S_{f}M⁴_{g})Xₕ [Chemical Formula 21]

In Chemical Formula 21, 4≤a≤8, M¹ may be Mg, Cu, Ag, or a combination thereof, 0≤b<0.5, M² is Na, K, or a combination thereof, 0≤c<0.5, M³ may be Sn, Zn, Si, Sb, Ge, or a combination thereof, 0<d<4, 0≤e<1, M⁴ may be O, SOₙ, N, or a combination thereof, 1.5≤n≤5, 3≤f≤12, 0≤g<2, and X may be F, Cl, Br, I, or a combination thereof, and 0≤h≤2.

In an implementation, in Chemical Formula 21, a halide element (X) may be necessarily included, and in this case, it may be expressed as 0<h≤2. In an implementation, the M¹ element may be necessarily included in Chemical Formula 21, and in this case, it may be expressed as 0<b<0.5. In Chemical Formula 21, M³ may be understood as an element substituted for P and may be 0<e<1. In Chemical Formula 21, M⁴ is substituted for S and, for example, may be 0<g<2, and f, a ratio of S, may be, e.g., 3≤f≤7. When M⁴ is SOₙ, SOₙ may be, e.g., S₄O₆, S₃O₆, S₂O₃, S₂O₄, S₂O₅, S₂O₆, S₂O₇, S₂O₈, SO₄, or SO₅, e.g., may be SO₄.

In an implementation, in Chemical Formula 21, a+b+c+h=7, d+e=1, and f+g+h=6.

In an implementation, the argyrodite-type sulfide solid electrolyte particles may include Li₃PS₄, Li₇P₃S₁₁, Li₇PS₆, Li₆PS₅Cl, Li₆PS₅Br, Li₅·PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

The argyrodite-type sulfide solid electrolyte may be prepared, e.g., by mixing lithium sulfide and phosphorus sulfide, and optionally lithium halide. Heat treatment may be performed after mixing them. The heat treatment may be carried out at a temperature range of about 400° C. to about 600° C., e.g., about 450° C. to about 500° C., or about 460° C. to about 490° C., for about 5 hours to about 30 hours, about 10 hours to about 24 hours, or about 15 hours to about 20 hours. Under the above conditions, ionic conductivity may be maximized. The heat treatment may include, e.g., two or more heat treatment steps. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D₅₀) of the sulfide solid electrolyte particles may be, e.g., about 0.1 μm to about 5.0 μm or about 0.1 μm to about 3.0 μm, and may be small particles of about 0.1 μm to about 1.9 μm or large particles of about 2.0 μm to about 5.0 μm. The sulfide solid electrolyte particles may be a mixture of small particles having an average particle diameter of about 0.1 μm to about 1.9 μm and large particles having an average particle diameter of about 2.0 μm to about 5.0 μm. The average particle diameter of the sulfide solid electrolyte particles may be measured using an electron microscope image, e.g., a particle size distribution may be obtained by measuring the size (diameter or length of the long axis) of about 20 particles in a scanning electron microscope image, and D₅₀ may be calculated therefrom.

### Oxide Solid Electrolyte

The oxide solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0≤x≤2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0≤x<2, 0≤y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M=Te, Nb, or Zr; x is an integer of 1 to 10), or a mixture thereof.

### Halide Solid Electrolyte

The solid electrolyte layer may further include, e.g., a halide solid electrolyte. The halide solid electrolyte may include a halogen element as a main component, meaning that a ratio of the halide element to all elements constituting the solid electrolyte is about 50 mol % or more, about 70 mol % or more, about 90 mol % or more, or about 100 mol %. As an example, the halide solid electrolyte may not include sulfur.

The halide solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, e.g., it may be Cl, Br, or a combination thereof. The halide solid electrolyte may be, e.g., represented by LiₐM₁X₆ (M may be Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X may be F, Cl, Br, I, or a combination thereof, and 2≤a≤3). The halide-based solid electrolyte may include, for example, Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

### Binder

The solid electrolyte layer may further include a binder. The binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The binder may be included in an amount of about 0.1 wt % to about 3 wt %, e.g., about 0.5 wt % to about 2 wt %, about 0.5 wt % to about 1.5 wt %, based on 100 wt % of the solid electrolyte layer. Within the above ranges, the components in the solid electrolyte layer may be well combined without reducing the ionic conductivity of the solid electrolyte, thereby improving durability and reliability of the battery.

### Other Components

In an implementation, the solid electrolyte layer may further include an alkali metal salt, an ionic liquid, or a conductive polymer.

The alkali metal salt may be, e.g., a lithium salt. A concentration of the lithium salt in the solid electrolyte layer may be greater than or equal to about 1 M, e.g., about 1 M to about 4 M. In this case, the lithium salt may help improve ionic conductivity by improving lithium ion mobility of the solid electrolyte layer.

In an implementation, the lithium salt may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro (oxalato)borate (LiDFOB), lithium difluorobis(oxalato)phosphate (LiDFBP), lithium bis(trifluoromethanesulfonyl)imide (LiTFSI), lithium bis(fluoro)sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may be an imide lithium salt such as LiTFSI, LiFSI, LiBETI, or a combination thereof. The imide lithium salt may help maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N⁻.

The ionic liquid may be, e.g., N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may help maintain or improve ionic conductivity by improving the electrochemical contact area with the electrode. In an implementation, the energy density, discharge capacity, rate capability, etc. of the all-solid-state rechargeable battery may be improved.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

In an implementation shape of the all-solid-state rechargeable battery may be, e.g., coin-shaped, button-shaped, sheet-shaped, stacked-shaped, cylindrical, flat, etc. In an implementation, the all-solid-state rechargeable battery may also be applied to large batteries used in electric vehicles, etc. In an implementation, the all-solid-state rechargeable battery may also be used in hybrid vehicles such as plug-in hybrid electric vehicles (PHEV). In an implementation, it may be used in a field requiring a large amount of power storage, and may be used, for example, in motorcycles, electric bicycles, drones, ships, trains, aviation equipment, or power tools. In an implementation, the all-solid-state rechargeable battery may be used in various fields such as portable electronic devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### 1. Manufacturing of Elastic Sheet

78.36 parts by weight of a polyol having a weight average molecular weight of 6,000 g/mol (VORANOL™ CP6001), 7.64 parts by weight of an isocyanate (Lupranate M11s, BASF SE), 0.025 parts by weight of 1,4-butanediol as a crosslinking agent, 0.125 parts by weight of dibutyltin dilaurate as a metal catalyst, 3.5 parts by weight of glass bubbles S60, 0.35 parts by weight of thermally expandable microspheres (FN-100MD), and 10 parts by weight of boron nitride as an insulating filler were mixed in a stirrer for 1 hour. The obtained mixture was coated on a PET film and then heated at 150° C. to form an about 300 m-thick urethane elastic sheet.

2. Manufacturing of all-Solid-State Rechargeable Battery Cell

85 wt % of LiNi_{0.8}Co_{0.15}Mn_{0.05}O₂ positive electrode active material coated with Li₂O—ZrO₂, 13.5 wt % of a lithium argyrodite-type solid electrolyte Li₆PS₅Cl, 1.0 wt % of a polyvinylidene fluoride binder, and 0.5 wt % of a carbon nanotube conductive material were mixed to prepare a positive electrode composition. The prepared positive electrode composition was coated on an aluminum positive electrode current collector, dried, and compressed to prepare a positive electrode.

A negative electrode coating layer composition was prepared by mixing carbon black having a primary particle diameter (D₅₀) of about 30 nm and silver (Ag) having an average particle diameter (D₅₀) of about 60 nm in a weight ratio of 3:1 to prepare an Ag/C composite and adding 0.25 g of the composite to 2 g of an NMP solution including 7 wt % of a polyvinylidene fluoride binder and then, mixing them. This was coated on a nickel foil current collector using a bar coater and dried in vacuum to prepare a precipitated negative electrode with a negative electrode coating layer formed on the current collector.

An argyrodite-type solid electrolyte Li₆PS₅Cl (D₅₀=3 μm) was added to a binder solution in which an acrylic binder (SX-A334, Zeon) was dissolved in an isobutyl isobutyrate (IBIB) solvent and stirred to prepare a slurry. The slurry included 98.5 wt % of the solid electrolyte and 1.5 wt % of the binder. The slurry was coated on a release PET film using a bar coater and dried at ambient temperature to prepare a solid electrolyte layer.

Bicell-type cell structures were manufactured by stacking in the order of negative electrode/solid electrolyte/positive electrode/solid electrolyte/negative electrode. The manufactured elastic sheet was interposed between the two cell structures and on the outermost layer of the cell structures. The laminated structure was placed in an aluminum pouch laminate film and subjected to isostatic pressure (WIP) at 500 MPa at 80° C. for 30 minutes to produce an all-solid-state rechargeable battery cell.

### Example 2

An elastic sheet and an all-solid-state rechargeable battery cell were manufactured substantially in the same manner as in Example 1 except that the glass bubbles and the thermally expandable microspheres were not used, and nitrogen was added at 200 cc/min thereto and then, stirred for 5 minutes to manufacture the elastic sheet.

### Comparative Example 1

An elastic sheet and an all-solid-state rechargeable battery cell were manufactured substantially in the same manner as in Example 1 except that a polyol having a weight average molecular weight of 3,400 g/mol (SANNIX FA-103) was used instead of the polyol having a weight average molecular weight of 6,000 g/mol.

### Comparative Example 2

An elastic sheet and an all-solid-state rechargeable battery cell were manufactured substantially in the same manner as in Example 2 except that a polyol having a weight average molecular weight of 3,400 g/mol (SANNIX FA-103) was used instead of the polyol having a weight average molecular weight of 6,000 g/mol.

### Comparative Example 3

An elastic sheet and an all-solid-state rechargeable battery cell were manufactured substantially in the same manner as in Example 1 except that the insulating filler was not used, and the content of each component was changed as shown in Table 1.

### Comparative Example 4

An elastic sheet and an all-solid-state rechargeable battery cell were manufactured substantially in the same manner as in Example 2 except that the insulating filler was not used, and the content of each component was changed as shown in Table 1.

The components and contents of the elastic sheets of the Examples and the Comparative Examples are shown in Table 1.

TABLE 1

| | | | Comp. | Comp. | Comp. | Comp. |
|---|---|---|---|---|---|---|
| (wt %) | Ex. 1 | Ex. 2 | Ex. 1 | Ex. 2 | Ex. 3 | Ex. 4 |
| Polyol | 78.36 | 81.83 | — | — | 87.36 | 90.87 |
| (Mw: 6,000) | | | | | | |
| Polyol | — | — | 78.35 | 81.83 | — | — |
| (Mw: 3,400) | | | | | | |
| Isocyanate | 7.64 | 8.02 | 7.64 | 8.02 | 8.64 | 8.98 |
| 1,4-butandiol | 0.025 | 0.025 | 0.025 | 0.025 | 0.025 | 0.025 |
| Dibutyltin | 0.125 | 0.125 | 0.125 | 0.125 | 0.125 | 0.125 |
| dilaurate | | | | | | |
| Glass bubbles | 3.5 | — | 3.5 | — | 3.5 | — |
| Thermally | 0.35 | — | 0.35 | — | 0.35 | — |
| expandable | | | | | | |
| microspheres | | | | | | |
| Nitrogen | — | ◯ | — | ◯ | — | ◯ |
| (200 cc/min) | | | | | | |
| Insulating filler | 10 | 10 | 10 | 10 | — | — |

### Example 3

### 1. Manufacturing of Elastic Sheet

42.93 parts by weight of 2-ethylhexyl acrylate, 21.46 parts by weight of isobornyl acrylate, and 21.46 parts by weight of 4-hydrobutyl acrylate were mixed, and then, 0.025 parts by weight of 1,6-hexanediol diacrylate as a crosslinking agent, 0.125 parts by weight of an initiator (Igacure 651), 0.5 parts by weight of polymer microspheres (820DET40), 3.5 parts by weight of glass bubbles K-1, and 10 parts by weight of boron nitride as an insulating filler were mixed therewith in a stirrer for 1 hour. The obtained mixture was coated on a PET film and then irradiated with ultraviolet rays at an intensity of 10 mW/cm² with a UV lamp for about 3 minutes to manufacture an about 300 μm-thick acryl elastic sheet.

Except for this, an all-solid-state rechargeable battery cell was manufactured substantially the same manner as in Example 1.

### Examples 4 to 7 and Comparative Examples 5 to 9

An elastic sheet and an all-solid-state rechargeable battery cell were manufactured substantially the same manner as in Example 3 except that the component and the content of the elastic sheet were respectively changed as shown in Table 2.

TABLE 2

| | | | | | | Comp. | Comp. | Comp. | Comp. | Comp. |
|---|---|---|---|---|---|---|---|---|---|---|
| (wt %) | Ex. 3 | Ex. 4 | Ex. 5 | Ex. 6 | Ex. 7 | Ex. 5 | Ex. 6 | Ex. 7 | Ex. 8 | Ex. 9 |
| 2-Ethylhexyl | 42.93 | 22.46 | 40.43 | 20.71 | 26.96 | 47.93 | 8.79 | 37.93 | 22.96 | 18.17 |
| acrylate | | | | | | | | | | |
| Isoborny1 | 21.46 | 44.93 | 20.21 | 41.43 | 35.94 | 23.96 | 65.89 | 18.96 | 45.93 | 18.17 |
| acrylate | | | | | | | | | | |
| 4- | 21.46 | 22.46 | 20.21 | 20.71 | 26.96 | 23.96 | 13.18 | 18.96 | 22.96 | 54.51 |
| Hydroxybutyl | | | | | | | | | | |
| acrylate | | | | | | | | | | |
| Crosslinking | 0.025 | 0.025 | 0.025 | 0.025 | 0.025 | 0.025 | 0.025 | 0.025 | 0.025 | 0.025 |
| agent | | | | | | | | | | |
| Initiator | 0.125 | 0.125 | 0.125 | 0.125 | 0.125 | 0.125 | 0.125 | 0.125 | 0.125 | 0.125 |
| Polymer | 0.5 | 0.5 | 0.5 | 0.5 | 0.5 | 0.5 | 0.5 | 0.5 | 0.5 | 0.5 |
| microspheres | | | | | | | | | | |
| Glass bubbles | 3.5 | 3.5 | 3.5 | 3.5 | 3.5 | 3.5 | 3.5 | 3.5 | 3.5 | 3.5 |
| Insulating | 10 | 6 | 15 | 13 | 6 | — | 8 | 20 | 4 | 5 |
| filler | | | | | | | | | | |

### Evaluation Example 1: Dielectric Breakdown Strength

Each of the elastic sheets according to the Examples and the Comparative Examples was placed between heavy cylindrical electrodes conducting a current with reference to a specimen thickness of 300 m according to ASTM D149. After applying an initial voltage thereto, a voltage where the specimen was broken was checked by increasing the voltage to 0.5 kV/sec at a constant rate and then, divided by a specimen thickness to obtain dielectric breakdown strength, and the results are shown in Tables 3 and 4.

### Evaluation Example 2: Elongation

Each of the elastic sheets according to the Examples and the Comparative Examples was measured with respect to elongation at 500 mm/min according to ASTM D3574, and the results are shown in Tables 3 and 4. The elongation refers to a degree to which a specimen was stretched in a tensile test.

### Evaluation Example 3: Tensile Strength

Each of the elastic sheets according to the Examples and the Comparative Examples was measured with respect to tensile strength at 500 mm/min according to ASTM D3574, and the results are shown in Tables 3 and 4.

### Evaluation Example 4: Penetration Test

Each of the elastic sheets with a thickness of 300 m according to the Examples and the Comparative Examples was penetrated by a pin with a diameter of 1 mmΦ at a speed of 0.1 mm/s, and the test results are shown in Tables 3 and 4.

TABLE 3

| | Ex. 1 | Ex. 2 | Ex. 3 | Ex. 4 | Ex. 5 | Ex. 6 | Ex. 7 |
|---|---|---|---|---|---|---|---|
| Dielectric breakdown | 11.8 | 12.1 | 10.2 | 7.3 | 15.7 | 14.4 | 7.5 |
| strength (kV/mm) | | | | | | | |
| Elongation (%) | 165.4 | 170.3 | 194.4 | 178.2 | 166.7 | 152.1 | 198.8 |
| (500 mm/min) | | | | | | | |
| Tensile strength | 4.6 | 4.3 | 4.3 | 3.8 | 4.7 | 5.8 | 3.2 |
| (MPa) | | | | | | | |
| Penetration test | Pass | Pass | Pass | Pass | Pass | Pass | Pass |
| (thickness: 300 um) | | | | | | | |

TABLE 4

| | Comp. | Comp. | Comp. | Comp. | Comp. | Comp. | Comp. | Comp. | Comp. |
|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 |
| Dielectric | 10.4 | 11.2 | 4.7 | 5.1 | 4.4 | 8.1 | 16.7 | 6.4 | 5.8 |
| breakdown | | | | | | | | | |
| strength | | | | | | | | | |
| (kV/mm) | | | | | | | | | |
| Elongation (%) | 129.6 | 132.4 | 205.7 | 223.9 | 250.7 | 150.4 | 150.7 | 178.2 | 138.1 |
| (500 mm/min) | | | | | | | | | |
| Tensile | 2.4 | 2.2 | 2.7 | 2.5 | 2.3 | 7.8 | 6.2 | 3.8 | 2.7 |
| strength | | | | | | | | | |
| (MPa) | | | | | | | | | |
| Penetration | ignition | ignition | ignition | ignition | ignition | ignition | ignition | ignition | ignition |
| test | | | | | | | | | |
| (thickness: | | | | | | | | | |
| 300 um) | | | | | | | | | |

Referring to Tables 3 and 4, the Examples satisfied dielectric breakdown strength of 7 kV/mm or more, tensile strength ranging 3 to 6 MPa, and elongation of 150% or more, and passed the penetration test without ignition. In addition, each of the elastic sheets according to the Examples maintained insulating properties to 90 μm, 30% of 300 μm of the initial thickness of each elastic sheet, which was stretched during the penetration test.

The urethane elastic sheets of Comparative Examples 1 and 2, to which a polyol with a low molecular weight was applied, exhibited tensile strength of less than 3 MPa and elongation of less than 150%, and the elastic sheets were broken during the penetration test and failed in acting as an insulating layer. The urethane elastic sheets of Comparative Examples 3 and 4, to which no insulating filler was applied, exhibited tensile strength of less than 3 MPa and low dielectric breakdown strength of less than 7 kV/mm and accordingly, maintained no insulating properties but ignited.

The acryl elastic sheet of Comparative Example 5 exhibited tensile strength of less than 3 MPa and dielectric breakdown strength of less than 7 kV/mm and accordingly, did not maintain insulating properties but ignited during the penetration. The elastic sheets of Comparative Examples 6 and 7 exhibited tensile strength of greater than 6 MPa and satisfied elongation of greater than or equal to 150% and accordingly, were broken and failed in acting as an insulating layer. The elastic sheet of Comparative Example 8 exhibited dielectric breakdown strength of less than 7 kV/mm and did not sufficiently maintain insulating properties and ignited during the penetration. The elastic sheet of Comparative Example 9 exhibited dielectric breakdown strength of less than 3 kV/mm and elongation of less than 150% and was broken during the penetration and failed in acting as an insulating layer.

In conclusion, it may be seen that an elastic sheet should have tensile strength of 3 MPa to 6 MPa, elongation of 150% or more, and simultaneously, dielectric breakdown strength of 7 kV/mm or more to prevent the ignition by the penetration.

### Evaluation Example 5: Battery Cell Penetration Evaluation

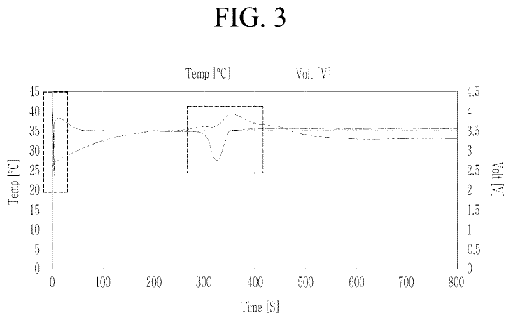

Regarding the all-solid-state rechargeable battery cell of Example 1, which was fully charged to a maximum voltage, a penetration experiment was performed at a speed of 0.1 mm/s to a depth of 2 mm by a nail with a diameter of 1 mmφ, and the results are shown in FIG. 3.

In FIG. 3, a left dotted line quadrangle shows a primary penetration result in which a short circuit occurred, but the voltage recovered, and a temperature did not rise significantly and went down again, and a middle dotted line quadrangle shows a secondary penetration result, in which the short circuit occurred, but the voltage recovered, and the temperature did not rise significantly and went down again like in the primary test. Herein, a maximum temperature was 39.2° C. Accordingly, the all-solid-state rechargeable battery cell of Example 1 effectively demonstrated insulation performance of the elastic sheet in the penetration test and exhibited neither exothermicity nor ignition.

By way of summation and review, some rechargeable lithium batteries may use an electrolyte solution including a flammable organic solvent, and they could explode or catch fire in response to, e.g., collision or penetration. Accordingly, semi-solid batteries or all-solid-state batteries that avoid the use of electrolyte solutions have been considered. An all-solid-state battery is a battery in which all materials are made of solid, e.g., a battery that uses solid electrolytes. This all-solid-state battery may have no risk of explosion due to electrolyte solution leakage and the like, and it may be easy to manufacture a thin battery.

One or more embodiments may provide an elastic sheet that may help prevent fire or explosion by preventing short-circuiting of the battery in abnormal situations such as penetration or collision, and may have improved withstand voltage characteristics and mechanical properties.

The elastic sheet according to some embodiments may have excellent withstand voltage characteristics and mechanical properties, and may help effectively prevent short circuit of the battery in abnormal situations such as penetration or collision, thereby preventing ignition and explosion.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An elastic sheet for an all-solid-state rechargeable battery, the elastic sheet comprising:
a curable resin; and
an insulating filler,
wherein the elastic sheet has:
a dielectric breakdown strength of about 7 kV/mm to about 15 kV/mm,
an elongation of greater than or equal to about 150%, and
a tensile strength of about 3 MPa to about 6 MPa.

2. The elastic sheet as claimed in claim 1, wherein the elastic sheet has a dielectric breakdown strength of about 7 kV/mm to about 16 kV/mm.

3. The elastic sheet as claimed in claim 1, wherein the elastic sheet has an elongation of about 150% to about 200%.

4. The elastic sheet as claimed in claim 1, wherein the elastic sheet has a thickness of about 100 μm to about 5 mm.

5. The elastic sheet as claimed in claim 4, wherein the elastic sheet has a thickness of about 100 μm to about 800 μm.

6. The elastic sheet as claimed in claim 1, wherein the elastic sheet is in a form of foam rubber, a sheet form, a foam sheet form, an injection molded product, or a foam injection molded product.

7. The elastic sheet as claimed in claim 1, wherein the curable resin comprises a urethane resin, an acrylic resin, a silicone resin, a fluorine resin, a styrene resin, a vinyl acetate resin, a rubber resin, a copolymer thereof, or a mixture thereof.

8. The elastic sheet as claimed in claim 1, wherein:
the curable resin comprises a urethane resin, and
the urethane resin is prepared from a polyol having a weight average molecular weight of greater than or equal to about 4,000 g/mol.

9. The elastic sheet as claimed in claim 8, wherein the urethane resin is prepared from a polyol having a weight average molecular weight of about 5,000 g/mol to about 10,000 g/mol.

10. The elastic sheet as claimed in claim 1, wherein the insulating filler comprises boron nitride (BN), silicon dioxide (SiO₂), alumina (AlO₃), zinc oxide (ZnO), aluminum hydroxide (Al(OH)₃), zirconia (ZrO₂), barium oxide (BaO), magnesium oxide (MgO₂), aluminum nitride (AlN), strontium oxide (SrO), or a combination thereof.

11. The elastic sheet as claimed in claim 1, wherein the insulating filler is in a particle form and has an average particle diameter (D₅₀) of about 10 nm to about 25 μm.

12. The elastic sheet as claimed in claim 1, wherein the insulating filler is included in an amount of about 5 parts by weight to about 30 parts by weight, based on 100 parts by weight of the curable resin.

13. The elastic sheet as claimed in claim 1, further comprising elastic particles,
wherein the elastic particles comprise a polymer of alkyl acrylate, olefin, butadiene, isoprene, styrene, acrylonitrile, a copolymer thereof, or a combination thereof.

14. The elastic sheet as claimed in claim 13, wherein the elastic particles have an average particle diameter (D₅₀) of about 10 nm to about 900 nm.

15. The elastic sheet as claimed in claim 14, wherein the elastic particles are included in an amount of about 0.1 parts by weight to about 5 parts by weight, based on 100 parts by weight of the curable resin.

16. The elastic sheet as claimed in claim 1, further comprising inorganic particles,
wherein the inorganic particles comprise titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or a combination thereof.

17. The elastic sheet as claimed in claim 16, wherein the inorganic particles are included in an amount of about 0.001 to about 50 parts by weight, based on 100 parts by weight of the curable resin.

18. The elastic sheet as claimed in claim 1, further comprising an additive,
wherein the additive comprises an initiator, a crosslinking agent, a coupling agent, a surfactant, or a combination thereof.

19. The elastic sheet as claimed in claim 18, wherein the additive is included in an amount of about 0.001 parts by weight to about 5 parts by weight, based on 100 parts by weight of the curable resin.

20. An all-solid-state rechargeable battery, comprising:
two or more cell structures, each cell structure comprising a positive electrode, a negative electrode, and a solid electrolyte layer, the solid electrolyte layer being between the positive electrode and negative electrode; and
the elastic sheet as claimed in claim 1 between the two or more cell structures or at an outermost portion of the two or more cell structures.
